(19) United States
(12) Patent Application Publication
(10) Pub. No.: US 2012/0026554 A1
(43) Pub. Date: Feb. 2, 2012

(54) IMAGE PROCESSING APPARATUS

(76) Inventor: Daisuke GENDA, Kawasaki-shi (JP)

(21) Appl. No.: 13/194,482

(22) Filed: Jul. 29, 2011

(30) Foreign Application Priority Data
Aug. 2, 2010 (JP) 2010-173700

(51) Int. Cl. G06K 15/02

(52) U.S. Cl. 358/3.27

(57) ABSTRACT

An image processing apparatus including: a contour extraction unit that extracts a contour pixel; a screen processing unit that sets a screen threshold matrix composed of a plurality of components each of which stores a threshold value, performs a screen process to input image data, and outputs processed image data; a screen dot determination unit that sets a dot output determination threshold matrix, and determines whether the screen dot is output to a first pixel or a second pixel around the first pixel; and a contour processing unit that outputs a pixel value of the processed image data to the contour pixel when the screen dot is output to the contour pixel or a pixel around the contour pixel, and outputs a contone pixel value to the contour pixel when the screen dot is not output to the contour pixel or the pixel around the contour pixel.

### BACKGROUND OF THE INVENTION

1. Field of the Invention

The present invention relates to an image processing apparatus.

2. Description of Related Art

In recent years, when an image forming apparatus such as a printer performs a screen process in order to express an image to be printed in a halftone, a phenomenon called jaggy, in which a contour of an image looks jagged, is caused. This is because, when the screen process is performed by using a screen pattern in which dots are regularly arranged, the dots (screen dots) are formed at every predetermined pixel. When the jaggy is caused, it is difficult to identify the contour of the image, which deteriorates the image quality.

In view of this, there has been proposed a technique in which a contour region of an image is extracted, and a contone process is performed to the contour region so as to add a contour. However, the portion where the contour and the screen dot are in contact with each other seems to be a screen dot larger than the other screen dots. Therefore, if such contact portions are dotted in the contour region, periodically or randomly, these portions look like the jaggy, which causes the problem of deterioration in an image.

There has been proposed a technique to perform a control as to whether a screen dot is output based on output states of a contour pixel and the pixels around contour pixel constituting a contour region of an image to which a screen process is performed, in order to eliminate the jaggy (see Japanese Patent Application Laid-Open No. 2006-180376).

However, the technique in Japanese Patent Application Laid-Open No. 2006-180376 needs a circuit (BLS unit) for determining whether the screen dot is output for each of the a plurality of surrounding pixels adjacent to the pixel of interest. When the image processing apparatus has an increased resolution to enhance an image quality in response to the recent trends, there might arise a problem in that a circuit scale for the screen process is increased. Specifically, a circuit structure of the BLS unit might be complicated, or the number of the BLS units might be increased, because of the increase in an amount of data for calculating a threshold value used in the BLS unit.

### SUMMARY OF THE INVENTION

An object of the present invention is to eliminate a jaggy in a contour region, while suppressing an increase in a circuit scale for a screen process.

To achieve the abovementioned object, an image processing apparatus reflecting one aspect of the present invention comprises: a contour extraction unit that extracts a contour pixel forming a contour region of an image in input image data; a screen processing unit that sets a screen threshold matrix composed of a plurality of components each of which stores a threshold value, performs a first screen process to the input image data by using the screen threshold matrix, and outputs processed image data; a screen dot determination unit that sets a dot output determination threshold matrix for determining whether a screen dot is output as a result of the first screen process by the screen processing unit to a first pixel or a second pixel around the first pixel of the input image data based on the screen threshold matrix, and determines whether the screen dot is output to the first pixel or the second pixel based on the dot output determination threshold matrix; and a contour processing unit that outputs a pixel value of the processed image data to the contour pixel extracted by the contour extraction unit, when the screen dot is output to the contour pixel or a pixel around the contour pixel, and outputs a contone pixel value generated based on the input image data to the contour pixel extracted by the contour extraction unit, when the screen dot is not output to the contour pixel or the pixel around the contour pixel.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram illustrating the functional configuration of an image forming apparatus according to an embodiment of the present invention;

FIG. 2 is a diagram illustrating a configuration which mainly functions, in an image processing unit when a screen process is performed;

FIG. 3 is a diagram illustrating an example of the configuration of a block of 3 pixels×3 pixels having a pixel of interest as a center;

FIG. 4 is a diagram illustrating an example of edge intensities of the surrounding pixels with respect to a pixel of interest;

FIG. 5 is a diagram illustrating a numerical value e allocated to each component in a cell, in the case of M=5, and N=5;

FIG. 6 is a diagram illustrating two threshold values corresponding to each component in a screen threshold matrix;

FIG. 7 is a diagram illustrating an example of a threshold function represented by an equation (10);

FIG. 8A is a diagram illustrating an example of a first threshold value corresponding to each component in an intermediate threshold matrix;

FIG. 8B is a diagram illustrating an example of a second threshold value corresponding to each component in a dot output determination threshold matrix;

FIG. 9 is a flowchart of a contour process performed in a contour processing unit;

FIG. 10A is a diagram illustrating an example of halftone input image data;

FIG. 10B is a diagram illustrating an example of processed image data output from an MLS block;

FIG. 10C is a diagram illustrating an example of output image data to which a conventional contour enhancement process is performed; and

FIG. 10D is a diagram illustrating an example of output image data to which a contour enhancement process is performed by applying the present embodiment of the present invention.

### DESCRIPTION OF THE PREFERRED EMBODIMENTS

An image processing apparatus according to an embodiment of the present invention will be described in detail below with reference to the drawings.

In the present embodiment, the present invention is described by employing an example of an image forming apparatus, such as a Multi-functional peripheral (MFP), provided with an image processing unit as an image processing apparatus that performs a screen process to an image. However, the present invention is not limited thereto. The present invention is applicable to any image processing apparatuses that perform the screen process to an image.

The configuration will firstly be described.

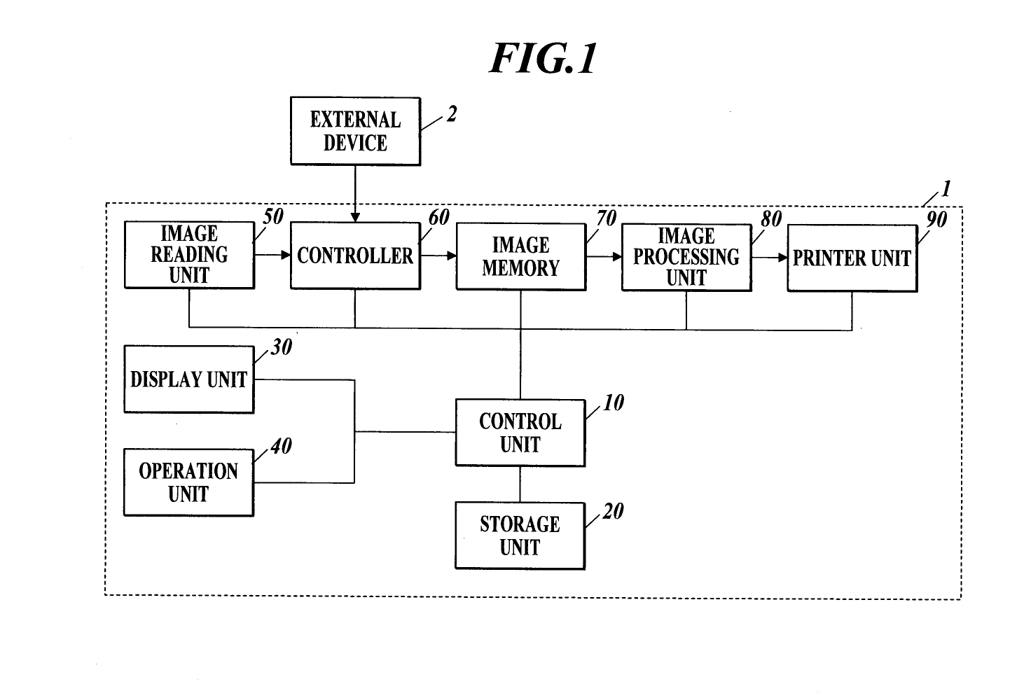

FIG. 1 illustrates a functional configuration of an image forming apparatus 1 according to the embodiment of the present invention.

As illustrated in FIG. 1, the image forming apparatus 1 includes a control unit 10, a storage unit 20, a display unit 30, an operation unit 40, an image reading unit 50, a controller 60, an image memory 70, an image processing unit 80, and a printer unit 90.

The control unit 10 includes a central processing unit (CPU), a random access memory (RAM), and the like. The control unit 10 reads a designated program or data from a system program, various application programs, and various data pieces stored in the storage unit 20, and develops the read program or data in the RAM. The control unit 10 then performs various processes in cooperation with the program developed in the RAM so as to make a central control to each unit in the image forming apparatus 1. For example, the control unit 10 makes an input/output control of image data to/from each unit, or a display control of the display unit 30, in a series of a printing operation.

The storage unit 20 stores the system program, the various application programs, various data pieces, and the like. For example, a non-volatile memory such as a hard disk drive (HDD) can be applied to the storage unit 20.

The display unit 30 includes a display made of a liquid crystal display (LCD), for example. The display unit 30 displays various screens for receiving inputs of various setting conditions or various processing results on the display according to a display signal input from the control unit 10.

The operation unit 40 includes a touch panel which covers the display of the display unit 30 and/or various operation keys, and the like. The operation unit 40 generates an operation signal according to an operation of the touch panel or the operation keys, and outputs the resultant to the control unit 10.

The image reading unit 50 includes an automatic document feeder (ADF), a reading unit and the like. The image reading unit 50 has a scanner function to read images of a plurality of documents and to generate image data (analog signal) by controlling the automatic document feeder and the reading unit based on an instruction from the control unit 10. The generated image data is separated by color into red (R), green (G), and blue (B). The generated image data is output to the controller 60.

The image means not only image data such as graphics and photographs, but also text data such as characters and symbols.

When the image forming apparatus 1 is used as a network printer, the controller 60 manages and controls the data transmitted from an external device 2 such as a personal computer (PC), which is connected to a network such as a local area network (LAN), to the image forming apparatus 1.

When the controller 60 receives data in a page-description language (PDL) format from the external device 2, the controller 60 performs a rasterization process to data in the PDL format so as to generate image data in which a density signal value (pixel value) for each pixel is determined. Specifically, the controller 60 analyzes a PDL command so as to allocate a pixel for every unit of an image to be drawn (hereinafter referred to as an object), and sets a density signal value for every allocated pixels to generate image data. Here, the explanation is made on the assumption that a pixel value from 0, which is the minimum value, to 255, which is the maximum value, is allocated to each pixel. In the case of a color image, image data for each color of cyan (C), magenta (M), yellow (Y), and black (K) is generated.

The controller 60 also analyzes the PDL command to generate attribute information TAG during the rasterization process. The attribute information TAG is information indicating which one of attributes among a text, graphics, and an image each pixel of an image belongs to. The controller 60 attaches the attribute information TAG to the generated image data, and outputs the resultant to the image memory 70.

The controller 60 makes a necessary process, such as analog/digital (A/D) conversion, to the image data input from the image reading unit 50, and then, makes a color conversion from RGB image data into CMYK image data and generates attribute information TAG for each pixel.

The image memory 70 includes a large-capacity memory such as an HDD, or a dynamic RAM (DRAM). The image memory 70 stores image data and the attribute information TAG input from the controller 60 in such a way that the data and information can be read and written. The image memory 70 stores and saves the image data input from the controller 60, or reads the image data stored in the image memory 70 and outputs the same to the image processing unit 80, according to the instruction from the control unit 10.

The image processing unit 80 performs various image processes to the image data input from the image memory 70. The image processes include an A/C conversion process, a shading process for correcting luminous unevenness caused by the image reading unit 50, I-I′ conversion process for converting a brightness characteristic unique to a scanner into an optimum brightness characteristic according to a man's visual characteristic, expanding, reducing, and rotating processes, a color conversion process, a density correcting process for correcting an image density into a density according to the man's visual characteristic, a screen process, and the like.

The image processing unit 80 outputs the image data, to which various image processes have already been performed, to the printer unit 90 as print data.

The printer unit 90 performs an image forming process for forming an image onto a sheet and outputting the resultant based on the print data input from the image processing unit 80. Any print systems can be employed in the printer unit 90. Here, an electrophotographic system is taken as an example. In the case of the electrophotographic system, the printer unit 90 includes an exposure unit, a developing unit, a sheet feeding unit, and a fixing unit. In the image forming process, a laser beam is irradiated to a photosensitive drum from a laser light source at the exposure unit to make an exposure, whereby an electrostatic latent image is formed. Then, the electrostatic latent image on the photosensitive drum is developed by the developing unit to form a toner image. The toner image on the photosensitive drum is transferred onto a sheet conveyed from the sheet feeding unit, and then, a fixing process is performed by the fixing unit. The sheet having the toner image fixed thereon is discharged onto a sheet discharge tray by a sheet discharge roller and the like.

The external device 2 includes printer driver software. The external device 2 converts data of a document or a photograph created in the external device 2 into data in the PDL format by the printer driver software. The external device 2 then transmits the data in the PDL format to the image forming apparatus 1.

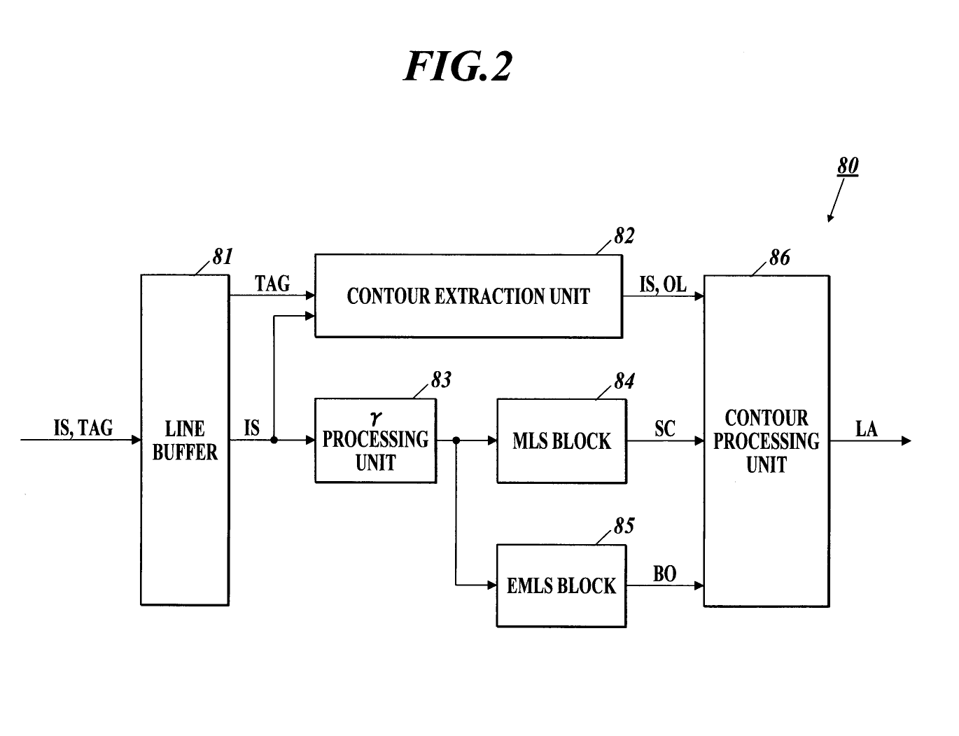

FIG. 2 illustrates a configuration, which mainly functions, in the image processing unit 80, when a screen process is performed.

As illustrated in FIG. 2, the image processing unit 80 includes a line buffer 81, a contour extraction unit 82, a γ processing unit 83, a multi level screen (MLS) block 84, an erase MLS (EMLS) block 85, a contour processing unit 86, a register (not illustrated) storing various data pieces required for the processes in the image processing unit 80, and the like.

The line buffer 81 stores and retains image data (hereinafter referred to as input image data IS) input from the image memory 70 and attribute information TAG. The line buffer 81 in the present embodiment retains the input image data IS for 4 lines and attribute information TAG for 3 lines. The line buffer 81 feeds the input image data IS, attribute information TAG, or both of them in a unit of a pixel or a unit of a block according to the process in each unit.

The number of lines of the input image data IS and the attribute information TAG stored and retained by the line buffer is only illustrative. The number of lines can appropriately be changed according to a unit of a block required for the image process.

The contour extraction unit 82 detects a contour region of an image in the input image data IS, generates a contour flag signal OL as contour information indicating as to whether each pixel is a pixel forming the contour region, and extracts the contour pixel forming the contour region of the image. The contour flag signal OL is generated for each color.

The process of generating the contour flag signal OL by the contour extraction unit will be described below.

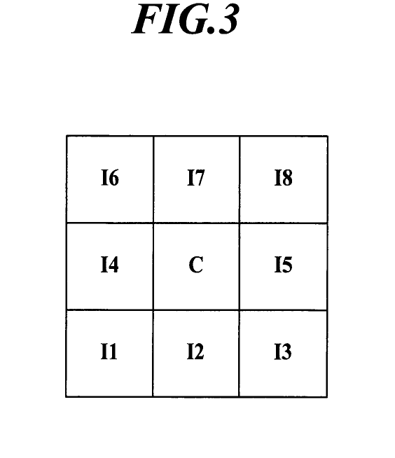

FIG. 3 illustrates an example of a configuration of a block of 3 pixels×3 pixels having a pixel of interest C as a center.

As illustrated in FIG. 3, a pixel of interest C is set to the input image data IS, and a block of 3 pixels×3 pixels having the pixel of interest C as a center is cut out to acquire surrounding pixels In (n=1 to 8). When the cut-out region includes a region outside the input image data IS, the pixel value of this region is defined as 0.

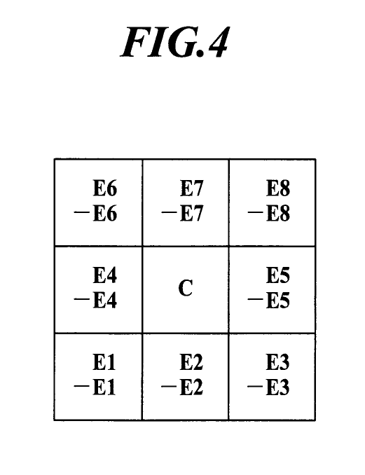

An edge intensity of each of the surrounding pixels In with respect to the pixel of interest C is generated based on the pixel value of each pixel included in the block of 3 pixels×3 pixels by using equations (1) and (2) described below. The edge intensities En and −En (n=1 to 8) mean a difference between the pixel value of the pixel of interest C and the pixel value of each of the surrounding pixels. FIG. 4 illustrates an example of the edge intensities of the surrounding pixels with respect to the pixel of interest C.

En[ch]=C[ch]−In[ch] (1)

−En[ch]=In[ch]−C[ch] (2)

In the equations, [ch] means a component indicating colors Y, M, C, and K of the image to be processed.

Among the calculated edge intensities, the maximum value in the positive direction is defined as a positive edge signal Ped[ch] in 4 pixels adjacent to the pixel of interest C. For example, the maximum value in E2, E4, E5, and E7 in the positive direction is defined as the positive edge signal Ped[ch] in FIG. 4. The maximum value in the negative direction in 4 pixels adjacent to the pixel of interest C is defined as a negative edge signal Red[ch]. For example, the maximum value in −E2, −E4, −E5, and −E7 in the negative direction is defined as the negative edge signal Red[ch] in FIG. 4. The positive edge signal Ped[ch] and the negative edge signal Red[ch] can be calculated by using equations (3) and (4) described below.

Ped[ch]=Max(E2[ch],E4[ch],E5[ch],E7[ch]) (3)

Red[ch]=Max(−E2[ch],−E4[ch],−E5[ch],−E7[ch]) (4)

In these equations, Ped[ch]=0, in the case of edTH>Ped[ch].

In these equations, Red[ch]=0, in the case of edTH>Red[ch].

(edTH is a threshold value set beforehand)

Max(X) is a function for outputting the maximum value.

The edge intensities En[ch], and −En[ch], the positive edge signal Ped[ch], and the negative edge signal Red[ch] obtained in the above-mentioned way are parameters indicating the edge intensity. By using the parameters indicating the edge intensity, Tp and Tr are obtained as an index value indicating a visual contrast at the edge portion between a character and a background.

Tp and Tr are calculated by using equations (5) and (6) described below.

Tp=(Ped[Y]×Wy+Ped[M]×Wm+Ped[C]×Wc+Ped[K]×Wk)/256 (5)

Tr=(Red[Y]×Wy+Red[M]×Wm+Red[C]×Wc+Red[K]×Wk)/256 (6)

Coefficients Wy, Wm, Wc, and Wk satisfy Wy+Wm+Wc+Wk 255.

When a process according to the visual density difference is required to be performed, a coefficient corresponding to a relative visibility may be applied to these coefficients Wy, Wm, Wc, and Wk. In the case of Y (yellow), even if the Y (yellow) has the maximum density, the visual density difference cannot be obtained compared to the other colors. On the other hand, the K (black) shows the greatest visual density difference. Considering these relationships, equations of Wy=16, Wm=32, We=80, and Wk=127 can be set, for example.

Next, Tp and Tr are compared.

When the condition of Tp>Tr is satisfied, it is determined that the pixel of interest C belongs to the contour region, whereby the contour flag signal OL is set to be 1, which indicates that the pixel of interest C is a pixel (hereinafter referred to as a contour pixel) forming the contour region. When the condition of Tp>Tr is not satisfied, it is determined that the pixel of interest C does not belong to the contour region, whereby the contour flag signal OL is set to be 0, which indicates that the pixel of interest C is not the contour pixel.

In the case of TAG=Image according to the attribute information TAG, the contour flag signal OL can always be set to 0. With this process, an unnecessary contour enhancement to a photographic image etc. can be avoided.

The contour flag signal OL generated for each pixel and the pixel value (pixel value of the pixel of interest C) of the input data IS for the contour flag signal OL are output to the contour processing unit 86.

The MLS block 84 will next be described.

The input image data IS output from the line buffer 81 is subject to the γ correction by the γ processing unit 83, and then, output to the MLS block 84. The MLS block 84 serves as a screen processing unit. Specifically, the MLS block 84 sets a screen threshold matrix composed of a plurality of components each of which stores two threshold values. The MLS block 84 performs a multivalued screen process (a first screen process) to the input image data IS, to which the γ correction has already been performed, by using the screen threshold matrix, thereby generating processed image data SC and outputting the same to the contour processing unit 86. The multivalued screen process is performed for each color.

The multivalued screen process performed in the MLS block 84 will be described below.

Firstly, a cell is set for the input image data IS, to which the γ correction has already been performed. Two threshold values TH1 and TH2 (TH1<TH2) corresponding to each component forming the cell are obtained to generate the screen threshold matrix. The cell is made of the components of M×N=n, in M columns in a main scanning direction and in N rows in a sub-scanning direction. The scanning is performed on the input image data IS, to which the γ correction has already been performed, in M pixel steps in the main scanning direction and in N pixel steps in the sub-scanning direction, with the screen threshold matrix.

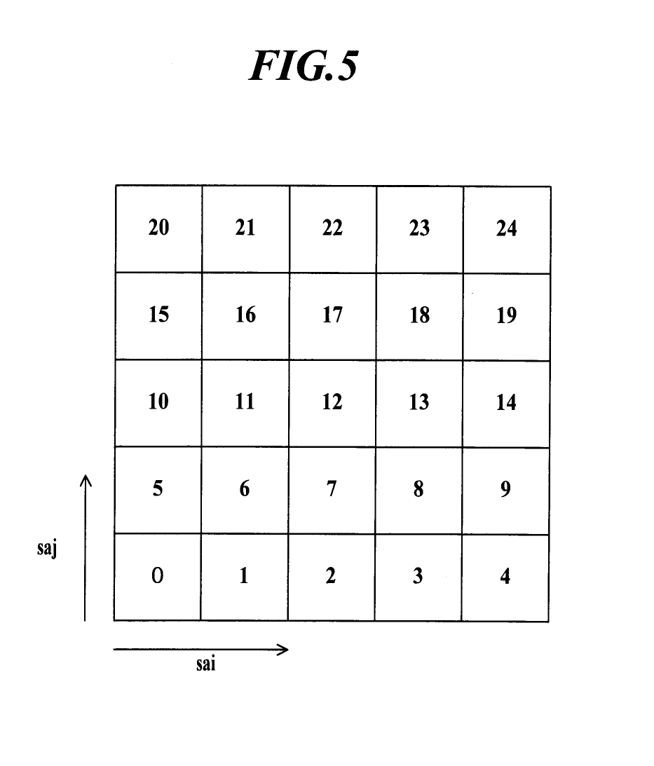

FIG. 5 illustrates a numerical value e allocated to each component in the cell, in the case of M=5, and N=5. The numerical value e is used for specifying the component corresponding to the pixel of interest C in the cell and the screen threshold matrix. Each numerical value e is calculated by using equations (7) to (9) described below.

e=sai+saj×M (7)

sai=i%M (8)

saj=j%N (9)

sai and saj represent positions in the cell of M×N (indexes representing the (sai)th column and (saj)th row), wherein the positional coordinate of the pixel of interest C is defined as (i, j).

The operator % is used to obtain a remainder by dividing the numerical value at the left of the operator % by the numerical value at the right of the operator %.

Tables TH1tb[ch] and TH2tb[ch], which are look-up tables (LUT) for determining the threshold values TH1 and TH2, are read from the register. The TH1tb[ch] and TH2tb[ch] are tables in which the output values TH1 and TH2 corresponding to an input value (the numerical value e which specifies each component) are set beforehand, respectively. The input value (numerical value e) is input to the TH1tb[ch] and TH2tb[ch] so as to obtain the corresponding output values TH1[ch][e] and TH2[ch][e], respectively. The TH1tb[ch] and TH2tb[ch] are generated in order to satisfy TH1[ch][e]<TH2[ch][e].

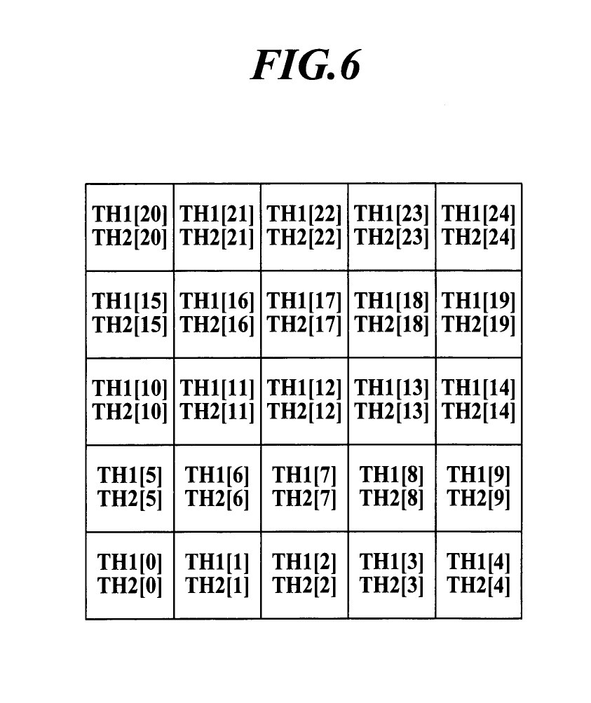

FIG. 6 illustrates two threshold values TH1[e] and TH2[e] corresponding to each component in the screen threshold matrix in a predetermined color (e.g., [ch]=K (black).

Next, the pixel values IS[ch][e] of the input image data IS, to which the γ correction has already been performed, is made multivalued by an equation (10) described below using two threshold values TH1tb[ch] and TH2tb[ch] in the screen threshold matrix, whereby a pixel value SC[ch][e] of the processed image data SC is obtained.

SC[ch][e]=(IS[ch][e]−TH1[ch][e])×255/(TH2[ch][e]−TH1[ch][e]) (10)

wherein SC [ch][e]=0 when SC [ch][e]<0 SC [ch][e]=255 when SC [ch][e]>255

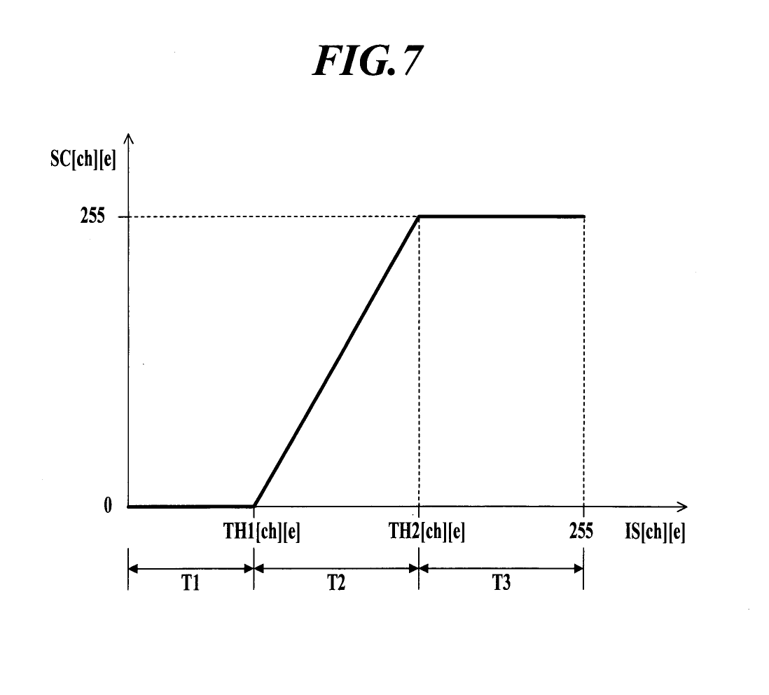

FIG. 7 illustrates an example of the threshold function represented by the equation (10) described above.

As illustrated in FIG. 7, the two threshold values TH1[ch][e] and TH2[ch][e] divides the range of the pixel values IS[ch][e] into three sections (a minimum-value section T1, an interpolation section T2, and a maximum-value section T3). When the pixel value IS[ch][e] of the input image data IS falls within the minimum-value section T1, the pixel value SC [ch][e] of the processed image data SC is converted into the minimum value (0). When the pixel value IS[ch][e] of the input image data IS falls within the interpolation section T2, the pixel value SC [ch][e] of the processed image data SC is converted into the value calculated by the equation (10). When the pixel value IS[e] of the input image data IS falls within the maximum-value section T3, the pixel value SC [ch][e] of the processed image data SC is converted into the maximum value (255) of the pixel value SC [ch][e] of the processed image data SC.

Next, the EMLS block 85 will be described.

The EMLS block 85 sets a dot output determination threshold matrix for determining whether a screen dot is output as a result of the multivalued screen process by the MLS block 84 to the pixel of interest C (first pixel) and a pixel (second pixel) around the pixel of interest C, based on the screen threshold matrix. The EMLS block 85 is a screen dot determination unit. Specifically, the EMLS block 85 performs a screen process (a second screen process) to the input image data IS, to which the γ correction has already been performed and which is input from the γ processing unit 83, based on the dot output determination threshold matrix, generates a dot output flag signal BO indicating whether the screen dot is output to the pixel of interest C or a pixel around the pixel of interest C, and outputs the dot output flag signal BO to the contour processing unit 86.

The screen threshold matrix used by the EMLS block 85 is the same as the screen threshold matrix for the MLS block 84. The process of calculating the numerical value e for specifying the pixel of interest C (component) in the screen threshold matrix and the process of setting the screen threshold matrix are the same as those for the MLS block 84. Therefore, the illustration and description thereof will not be repeated.

A first threshold value Bth1[ch][e] corresponding to each component in the screen threshold matrix used in the EMLS block 85 is calculated by using two threshold values TH1[ch][e] and TH2[ch][e], which are set in the same manner as in the MLS block 84, corresponding to each component in the threshold matrix, and by using an equation (11) described below, whereby an intermediate threshold matrix is set.

Bth1[ch][e]=TH1[ch][e]+(TH2[ch][e]−TH1[ch][e])×PON/100 (11)

It is to be noted that a weighing coefficient PON satisfies 0≦PON≦100.

Then, a second threshold value Bth2[ch][e] serving as a dot output determination threshold value for determining whether the screen dot is output to the pixel of interest C or a pixel around the pixel of interest C is calculated by using the first threshold value of the component corresponding to the pixel of interest C, the first threshold value of the pixel around the pixel of interest C, and an equation (12) described below, for each pixel of interest C (for each component), whereby the dot output determination threshold matrix is set.

Bth2[ch][e]=MIN(Bth1[i,j−1],Bth1[i−1,j],Bth1[i,j],Bth1[i+1,j],Bth1[i,j+1]) (12)

It is to be noted that MIN (X) is a function for outputting the minimum value.

The positional coordinate of the pixel of interest C is defined as (i, j).

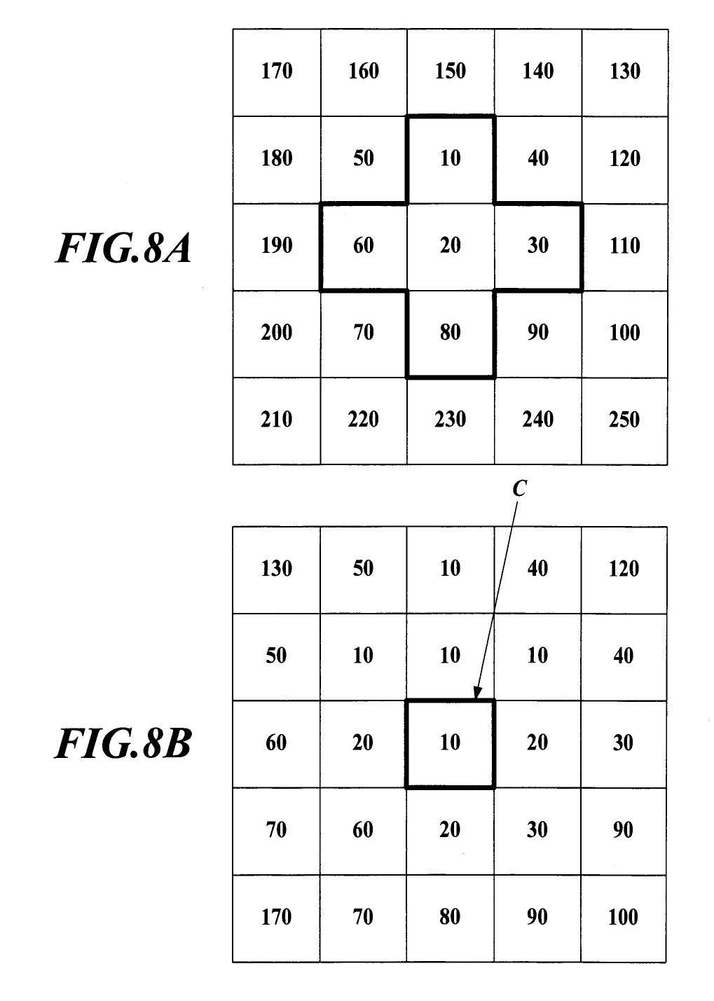

FIG. 8A illustrates an example of the first threshold value Bth1[ch][e] corresponding to each component in the intermediate threshold matrix, while FIG. 8B illustrates an example of the second threshold value Bth2[ch][e] corresponding to each component in the dot output determination threshold matrix.

As illustrated in FIGS. 8A and 8B, the minimum threshold value among the first threshold values of the pixels of interest C and the first threshold values of four pixels around the pixel of interest C is set to the second threshold value Bth2[ch][e] of each of the pixels of interest C. As the second threshold value of the pixel of interest C (e=12) enclosed by a bold frame illustrated in FIG. 8B, the minimum value 10 among the first threshold values Bth1[ch][7]=80, Bth1[11]=60, Bth1[12]=20, Bth1[13]=30, and Bth1[17]=10 of the pixels (e=7, 11, 12, 13, 17, respectively) enclosed by the bold frame in FIG. 8A is set.

The second threshold values Bth2[ch][e] of the pixels of interest C (e.g., e=0, 4, 20, 24) located at four corners in the dot output determination threshold matrix can be calculated by assuming that the intermediate threshold matrix of M pixels by N pixels is repeatedly placed in series in the main scanning direction and in the sub-scanning direction, and by using the first threshold values of the intermediate threshold matrices including those of the adjacent intermediate threshold matrices. That is based on the fact that the screen threshold matrix of M pixels by N pixels is repeatedly placed in series in the main scanning direction and in the sub-scanning direction.

In the present embodiment, as the second threshold value Bth2[ch][e] of each of the pixels of interest C, the minimum threshold value among the first threshold value Bth1[ch][e] of each of the pixels of interest C and the first threshold values Bth1[ch][e] of four pixels around the pixel of interest C is set. However, the present invention is not limited thereto.

For example, the minimum value among the first threshold value of each of the pixels of interest C and the first threshold values of eight pixels around the pixel of interest C may be set. Moreover, the present invention is configured so that the minimum value among the first threshold value of each of the pixels of interest C and the first threshold values of the pixels around the pixel of interest C is set to the second threshold value. However, the invention is not limited thereto. For example, the second lowest value of the first threshold value of each of the pixels of interest C and the first threshold values of the pixels around the pixel of interest C, or the average value of these first threshold values may be set as the second threshold value.

After the setting of the dot output determination threshold matrix, the screen process is performed to the input image data IS, to which the γ correction has already been performed, by using the dot output determination threshold matrix. In the screen process by the EMLS block 85, it is only necessary to determine whether the screen dot is output to the pixel of interest C or to the pixels around the pixel of interest C for each pixel. That is, the pixel value to which the screen process has already been performed is unnecessary. Therefore, it is only necessary to determine whether the pixel value of the pixel of interest C of the input image data IS, to which the γ correction has already been performed, is equal to or more than the second threshold value.

Specifically, after the second threshold value Bth2[ch][e] of the pixel of interest C is set, the pixel value IS[ch][e] of the pixel of interest C in the input image data IS, to which the γ correction has already been performed, and the second threshold value Bth2[ch][e] corresponding to the pixel of interest C are compared to each other. When the condition of IS[ch][e]≧Bth2[ch][e] is satisfied, it is determined that the screen dot is output to the pixel of interest C or the pixels around the pixel of interest C, whereby the dot output flag BO is set to 1. When the condition of IS[ch][e]≧Bth2[ch][e] is not satisfied, it is determined that the screen dot is not output to the pixel of interest C or the pixels around the pixel of interest C, whereby the dot output flag BO is set to 0.

The contour processing unit 86 makes an output control of a contone pixel value, which is generated based on the pixel value of the processed image data SC or the input image data IS, with respect to the contour pixel, based on the contour flag signal OL input from the contour extraction unit 82, the processed image data SC input from the MLS block 84, and the dot output flag signal BO input from the EMLS block 85.

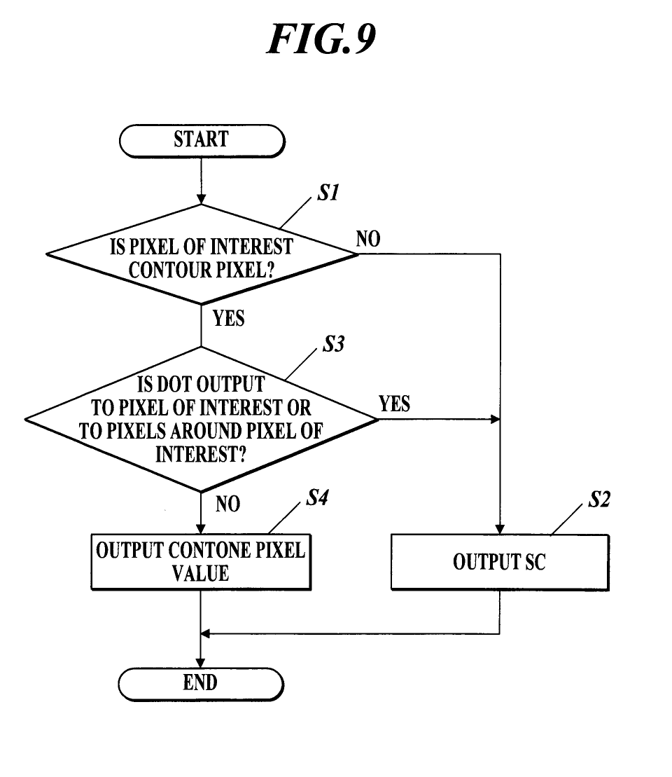

FIG. 9 illustrates a flowchart of a contour process performed in the contour processing unit 86.

Firstly, it is determined whether the pixel of interest C is the contour pixel by referring to the contour flag signal OL of the pixel of interest C input from the contour extraction unit 82 (step S1). That is, in step S1, it is specified whether the pixel of interest C is the contour pixel based on the contour flag signal OL.

When the contour flag signal OL is 0, which means the pixel of interest C is not the contour pixel (step S1: NO), the pixel value of the processed image data SC is output as the output pixel value LA of the pixel of interest C (step S2).

When the contour flag OL is 1, which means that the pixel of interest C is the contour pixel (step S1: YES), it is determined whether the screen dot is output to the pixel of interest C or the pixels around the pixel of interest C by referring to the dot output flag signal BO of the pixel of interest C input from the EMLS block 85 (step S3).

When the dot output flag signal BO is 1, which means the screen dot is output to the pixel of interest C or the pixels around the pixel of interest C (step S3: YES), the process in step S2 is performed.

When the dot output flag signal BO is 0, which means the screen dot is not output to the pixel of interest C or the pixels around the pixel of interest C (step S3: NO), the contone pixel value based on the input image data IS is generated as the output pixel value LA of the pixel of interest C, and the contone pixel value is output (step S4).

The contone pixel value is determined to be the pixel value that is set beforehand according to the pixel value of the pixel of interest C in the input image data IS, or is determined to be the pixel value that is set beforehand according to the pixel values of the pixel of interest C and the pixels around the pixel of interest C in the input image data IS to which the contone pixel value is to be output.

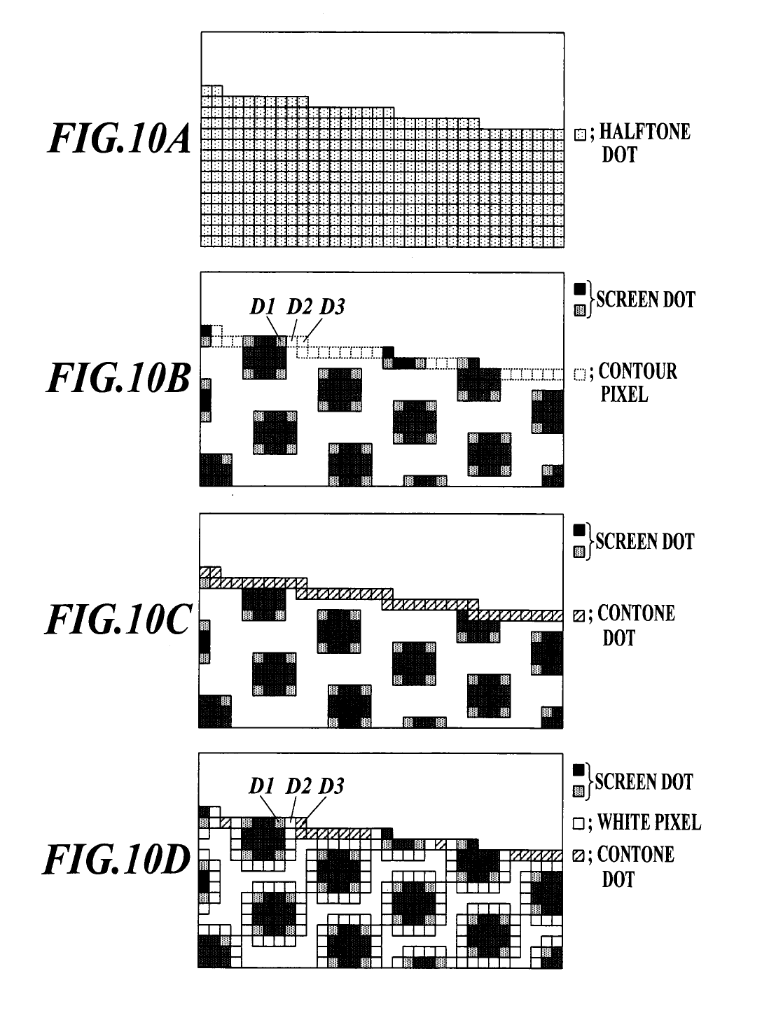

FIG. 10A illustrates an example of the halftone input image data IS, FIG. 10B illustrates an example of the processed image data SC output from the MLS block, FIG. 10C illustrates an example of the output image data to which a conventional contour enhancement process is performed, and FIG. 10D illustrates an example of the output image data to which a contour enhancement process is performed by applying the present embodiment.

When the screen process is performed to the input image data IS illustrated in FIG. 10A, a phenomenon called jaggy is caused in which the contour portion looks jagged as illustrated in FIG. 10B. Therefore, when contone dots are output to the contour pixels as illustrated in FIG. 10C, the portion where the contone dot and the screen dot are in contact with each other looks like a large screen dot compared to the portion of the screen dot that is not in contact with contone dots. Therefore, as illustrated in FIG. 10C, when the portions where the contone dot and the screen dot are in contact with each other are dotted, these portions appear as the jaggy.

On the other hand, when the present embodiment of the present invention is applied as illustrated in FIG. 10D, the pixel value of the processed image data SC is output to the contour pixel to which the screen dot is output or to the pixels around the contour pixel. As a result, the adjacent contact of the screen dot and the contone dot can be prevented.

For example, when a pixel D1 illustrated in FIG. 10D is the contour pixel to which the screen dot is output as illustrated in FIG. 10B, the screen dot is output to the pixel D1, since the pixel value of the processed image data SC is output. To a pixel D2, which is the pixel around the contour pixel D1 to which the screen dot is output, the pixel value of the processed image data SC is output. The pixel value of the processed image data SC of the pixel D2 is 0 as illustrated in FIG. 10B, so that the screen dot is not output to the pixel D2. Therefore, the pixel D2 is a white pixel as illustrated in FIG. 10D (the screen dot is not output). Further, when the pixel D3 illustrated in FIG. 10D is the contour pixel and at the same time, when the screen dot is not output to the contour pixel D3 and to the surrounding pixels thereof as illustrated in FIG. 10B, the contone pixel value based on the input image data IS is output, whereby the contone dot is output to the pixel D3.

Therefore, the screen dot of the contour pixel D1 and the contone dot of the contour pixel D3 are arranged with the contour pixel D2, i.e., a white pixel, in between, which can prevent the contact of the screen dot and the contone dot.

As described above, according to the present embodiment, the output of the contone dot based on the input image data IS is inhibited to the contour pixel to which a screen dot is output or to the pixels around the contour pixel, so that the pixel value based on the processed image data SC can be output. Therefore, the adjacent contact of the screen dot and the contone dot can be prevented, whereby the jaggy can be eliminated. The EMLS block 85 sets the dot output determination threshold matrix based on the screen threshold matrix identical to the screen threshold matrix used for the MLS block 84, and it can be determined whether the screen dot is output to a pixel or a pixel around the pixel according to the dot output determination threshold matrix. Consequently, it is unnecessary to provide a circuit, which determines whether the screen dot is output, to the number corresponding to the number of the surrounding pixels. The present invention can also prevent the circuit structure for setting the threshold value, which is used for determining whether the screen dot is output, from being complicated due to the increased resolution.

Therefore, the present invention can eliminate the jaggy in the contour region, while preventing the increase in the circuit scale for the screen process.

The dot output determination threshold matrix can be set in such a manner that the minimum threshold value among the threshold values corresponding to the component (first component) in the screen threshold matrix and to the components (second component) around the component (first component) is set as the dot output determination threshold value. Since the minimum threshold value, among the threshold value corresponding to the component and the threshold values corresponding to the components around the component, is set as the dot output determination threshold value, the threshold matrix, in which the occurrence frequency of the dot output is increased, can be obtained, compared to the case where the threshold value in the screen threshold matrix is used. Therefore, when the screen process is performed by using the threshold matrix, it can be determined whether the screen dot is output to the pixel corresponding to the component and to the component around the component.

In addition, the processed image data SC to which the multivalued screen process is performed can be obtained by the MLS block 84. Even if the MLS block 84 performs the multivalued screen process, the EMLS block 85 can set the dot output determination threshold matrix based on two threshold values corresponding to each component in the screen threshold matrix.

The EMLS block 85 can also determine whether the screen dot is output to the pixel or the pixel around the pixel according to the result of the screen process with respect to the input image data IS by using the dot output determination threshold matrix.

The present invention is not limited to the abovementioned embodiment, and various modifications are possible without departing from the scope of the present invention.

According to an aspect of the preferred embodiments of the present invention, there is provided an image processing apparatus including: a contour extraction unit that extracts a contour pixel forming a contour region of an image in input image data; a screen processing unit that sets a screen threshold matrix composed of a plurality of components each of which stores a threshold value, performs a first screen process to the input image data by using the screen threshold matrix, and outputs processed image data; a screen dot determination unit that sets a dot output determination threshold matrix for determining whether a screen dot is output as a result of the first screen process by the screen processing unit to a first pixel or a second pixel around the first pixel of the input image data based on the screen threshold matrix, and determines whether the screen dot is output to the first pixel or the second pixel based on the dot output determination threshold matrix; and a contour processing unit that outputs a pixel value of the processed image data to the contour pixel extracted by the contour extraction unit, when the screen dot is output to the contour pixel or a pixel around the contour pixel, and outputs a contone pixel value generated based on the input image data to the contour pixel extracted by the contour extraction unit, when the screen dot is not output to the contour pixel or the pixel around the contour pixel.

Preferably, the screen dot determination unit sets the dot output determination threshold matrix based on the screen threshold matrix in such a manner that a minimum threshold value among a threshold value corresponding to a first component and a threshold value corresponding to a second component around the first component in the screen threshold matrix is set as a dot output determination threshold value, for each of the components.

Preferably, the screen processing unit sets the screen threshold matrix in which each of the components stores two threshold values, performs a multivalued screen process to the input image data by using the screen threshold matrix, and outputs the processed image data.

Preferably, the screen dot determination unit sets an intermediate threshold matrix which stores a first threshold value corresponding to each of the components of the screen threshold matrix based on the two threshold values corresponding to each of the components, and sets the dot output determination threshold matrix based on the intermediate threshold matrix.

Preferably, the screen dot determination unit performs a second screen process to the input image data by using the dot output determination threshold matrix, and determines whether the screen dot is output to the first pixel or the second pixel as a result of the second screen process.

The entire disclosure of Japanese Patent Application No. 2010-173700 filed on Aug. 2, 2010 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An image processing apparatus comprising:
a contour extraction unit that extracts a contour pixel forming a contour region of an image in input image data;
a screen processing unit that sets a screen threshold matrix composed of a plurality of components each of which stores a threshold value, performs a first screen process to the input image data by using the screen threshold matrix, and outputs processed image data;
a screen dot determination unit that sets a dot output determination threshold matrix for determining whether a screen dot is output as a result of the first screen process by the screen processing unit to a first pixel or a second pixel around the first pixel of the input image data based on the screen threshold matrix, and determines whether the screen dot is output to the first pixel or the second pixel based on the dot output determination threshold matrix; and
a contour processing unit that outputs a pixel value of the processed image data to the contour pixel extracted by the contour extraction unit, when the screen dot is output to the contour pixel or a pixel around the contour pixel, and outputs a contone pixel value generated based on the input image data to the contour pixel extracted by the contour extraction unit, when the screen dot is not output to the contour pixel or the pixel around the contour pixel.

2. The image processing apparatus according to claim 1, wherein the screen dot determination unit sets the dot output determination threshold matrix based on the screen threshold matrix in such a manner that a minimum threshold value among a threshold value corresponding to a first component and a threshold value corresponding to a second component around the first component in the screen threshold matrix is set as a dot output determination threshold value, for each of the components.

3. The image processing apparatus according to claim 1, wherein the screen processing unit sets the screen threshold matrix in which each of the components stores two threshold values, performs a multivalued screen process to the input image data by using the screen threshold matrix, and outputs the processed image data.

4. The image processing apparatus according to claim 3, wherein the screen dot determination unit sets an intermediate threshold matrix which stores a first threshold value corresponding to each of the components of the screen threshold matrix based on the two threshold values corresponding to each of the components, and sets the dot output determination threshold matrix based on the intermediate threshold matrix.

5. The image processing apparatus according to claim 1, wherein the screen dot determination unit performs a second screen process to the input image data by using the dot output determination threshold matrix, and determines whether the screen dot is output to the first pixel or the second pixel as a result of the second screen process.
